(19) United States
(12) Patent Application Publication
(10) Pub. No.: US 2021/0137300 A1
(43) Pub. Date: May 13, 2021

(54) Pressure Cooker and Air Fryer Appliance

(71) Applicant: NuWave, LLC, Libertyville, IL (US)

(72) Inventors: Jay Moon, Long Grove, IL (US); Byung Gab Choi, Lake Villa, IL (US); James K. Moon, Vernon Hills, IL (US); Zeng Qing Ping, Shanwei City (CN); Jong Rok Kim, Seoul (KR); Luo Fei, Shunde District (CN); DingYu Hu, Foshan (CN)

(21) Appl. No.: 16/683,009

(22) Filed: Nov. 13, 2019

(51) Int. Cl. A47J 27/12; A47J 27/08; A47J 27/086; A47J 27/09; A47J 27/00; A47J 37/12

(52) U.S. Cl. CPC A47J 27/12; A47J 27/0802; A47J 27/0815; A47J 27/086; A47J 27/09; A47J 2202/00; A47J 37/1257; A47J 37/1266; A47J 37/128; A47J 2201/00; A47J 27/002

(57) ABSTRACT

An electrical appliance for cooking food by two different methods is disclosed. Generally speaking, the appliance comprises a base and two interchangeable cooking lids. The base has an outer surface, an inner cooking chamber open at an upper end, a first heating source coupled to the cooking chamber, an electronic controller for controlling the heating source, and a user interface having a plurality of buttons for inputting cooking parameters to the electronic controller. The first interchangeable lid is securable to the base to cover the open end of the cooking chamber and is movable on the base from a closed and locked position to a closed and unlocked position. Similarly, the second interchangeable lid is positionable atop the base to cover the open end of the cooking chamber and includes a second heating source, an air circulating device and a power connector configured to receive power through a corresponding power connector positioned on the base.

### TECHNICAL FIELD OF THE INVENTION

The present disclosure relates to cooking appliances. More specifically, the invention relates to countertop cooking appliances. Most specifically, the disclosed device relates to an electric, multi-purpose, countertop cooking appliance.

### BACKGROUND OF THE INVENTION

There are countless kitchen countertop appliances being sold, on television, on the Internet, and in stores, which focus on doing one thing. Specific countertop appliances include convection ovens, toasters, deep fryers, microwaves, pressure cookers, and the like. With a need to have every cooking option available, consumers are running out of counter space and storage space. Having multiple clunky cooking appliances is impractical, especially with a trend toward smaller living spaces such as apartments, condominiums, and tiny houses.

Additionally, appliances which are capable of carrying out two or more cooking methods promote creativity, decrease food waste, and increase cooking efficiency. With the help of the disclosed system and method, consumers can thoroughly cook and crisp their food to perfection.

Previous inventions have addressed pressure cooking and air frying singularly. However, none have combined the concepts. This limits the cooking options available to consumers or requires them to purchase two different appliances. The system and method described here not only cut down on space taken up by multiple appliances but it also provides a more economical choice.

Until the system and method of the present application, these and other problems in the prior art went either unnoticed or unsolved by those skilled in the art. The present system provides a cooking appliance which performs multiple cooking functions with the associated device without sacrificing features such as simplicity of use, design, style or affordability.

### SUMMARY OF THE INVENTION

There is disclosed herein a dual cooking appliance which avoids the disadvantages of prior devices while affording additional structural and operating advantages.

Generally speaking, the disclosed appliance is for cooking food by two different methods. The appliance comprises a base and two interchangeable cooking lids.

The base has an outer surface, an inner cooking chamber open at an upper end, a first heating source coupled to the cooking chamber, an electronic controller for controlling the heating source, a power cord for connecting to a power source, and a user interface positioned on an outer surface and having a plurality of buttons for inputting cooking parameters to the electronic controller.

The first interchangeable lid is securable to the base to cover the open end of the cooking chamber and is movable on the base from a closed and locked position to a closed and unlocked position. Similarly, the second interchangeable lid is positionable atop the base to cover the open end of the cooking chamber and comprises a second heating source, an air circulating device and a power connector configured to receive power through a corresponding power connector positioned on the base and electrically coupled to the power cord.

In a preferred embodiment, the first interchangeable lid attaches to the base to create a cooking appliance configured for a first cooking method and the second interchangeable lid alternately attaches to the base to create a cooking appliance configured for a second cooking method different from the first cooking method.

In specific embodiments, the appliance further comprises at least one first locking flange positioned about a periphery of the open end of the cooking chamber, and at least one second locking flange positioned about a periphery of an internal surface of the first interchangeable lid. The at least one second locking flange is operatively engageable with the at least one first locking flange to secure the first interchangeable lid to the cooking vessel in the closed orientation. Preferably, the first interchangeable lid rotates about the open end of the cooking chamber to move from the locked position to the unlocked position.

Also disclosed is a method for preparing food in a single appliance using two consecutive and different cooking methods.

Generally speaking, the disclosed method comprises providing an appliance as described above, placing food into the cooking chamber, attaching the first interchangeable lid to the base and moving the lid to the closed and locked position, inputting cooking parameters for a first cooking method using the user interface, inputting cooking parameters for a second cooking method, different from the first cooking method, using the user interface, activating the appliance to begin the first cooking method, signaling the completion of the first cooking method, detaching the first interchangeable lid from the base, placing the second interchangeable lid onto the base, activating the appliance to begin the second cooking method, signaling the completing of the second cooking method, removing the second interchangeable lid from the base, and removing the food from the cooking chamber.

In specific embodiments of the method, the first cooking method is pressure cooking and/or the second cooking method is air frying.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is an exploded view of an embodiment of the disclosed cooking appliance showing both of the interchangeable cooking lids;

FIG. 2 is a front plan view of an embodiment of the disclosed appliance with each of the two different lids positioned onto the base unit;

FIG. 3 is a front perspective view of an embodiment of the pressure cooker of the disclosed appliance;

FIG. 4 is a front perspective view of an embodiment of the air fryer of the disclosed appliance;

FIG. 5 is a schematic of an embodiment of the user interface;

FIG. 6 is a schematic illustrating an embodiment of the controller connected to the user interface, the heating element in the base unit and the electrical connector for the air fryer lid;

FIG. 7 is a front perspective view of an embodiment of the user interface on the base unit;

FIG. 8 is a front perspective view of an embodiment of the base unit;

FIG. 9 is a front perspective view of the pressure cooker having the lid in a closed and unlocked position;

FIG. 10 is a top view of an embodiment of the pressure cooker lid;

FIG. 11 is another top view of the pressure cooker lid of FIG. 10;

FIG. 12 is a bottom view of the pressure cooker lid of FIG. 10;

FIG. 13 is a close-up view of the bottom of the pressure cooker lid of FIG. 10;

FIG. 14 is a close-up view of the pressure valve of the pressure cooker lid of FIG. 10;

FIG. 15 is a top perspective view of an embodiment of the air fryer lid;

FIG. 16 is a side perspective view of the air fryer lid of FIG. 15;

FIG. 17 is a bottom plan view of the underside of the air fryer lid of FIG. 15;

FIG. 18 is a partial close-up of the underside of the air fryer lid of FIG. 15;

FIG. 19 is a partial view of an embodiment of the base unit;

FIG. 20 is a perspective view of the base unit of FIG. 19;

FIG. 21 is a close-up view of the safety switch on the base unit;

FIG. 22 is a side view of the base unit of FIG. 19;

FIG. 23 is a rear view of the base unit of FIG. 19 showing a water drawer;

FIG. 24 is a partial close-up view showing the base power connector to the air fryer lid;

FIG. 25 is a perspective view of an embodiment of the pressure cooker pot;

FIG. 26 is a perspective view of the pot of FIG. 25 within the appliance cooking chamber;

FIG. 27 is a top view of a wire lid rack;

FIG. 28 is a top view of an air fryer basket stand;

FIG. 29 is a side view of an embodiment of an air fryer basket; and

FIG. 30 is a top perspective view of the air fryer basket and stand assembly.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

Referring to FIGS. 1-30, there is illustrated a cooking appliance, generally designated by the numeral 10. The particular illustrated appliance 10 is for alternately or consecutively preparing food using two different cooking techniques or methods: pressure cooking and air frying. However, while the illustrations are directed to a specific embodiment of the appliance, it should be understood that the principles of the invention can be more broadly applied to encompass alternate embodiments and cooking methods, as long as such embodiments read on the limitations of the claims set forth in this application.

As can be seen in FIG. 1, the cooking appliance 10 is comprised of a base unit 12 and two alternate cooking lids: pressure cooker lid 14 and air fryer lid 16. The appliance 10 may also include additional components for cooking, such as a graduated pot 20, a food rack 22, a food basket 24, as well as other components useful in the disclosed cooking methods.

Referring to FIGS. 2-8, the cooking appliance 10 in each of its forms is most clearly illustrated. The pressure cooker 10a includes the pressure cooker lid 14 secured to the base 12. The air fryer lob includes the air fryer lid 16 positioned on the base 12. The base 12 includes a user interface panel 18 which connects to an electronic controller 26 within the appliance housing 30. The controller 26 operates the appliance 10 in accordance with a set of input cooking parameters e.g., time and temperature. The interface 18, as shown best in FIGS. 5 and 7, may include preprogrammed buttons 30 as well as programming buttons 32. The preprogrammed buttons 30 might include common cooking settings, such as “sear” and “warm” which are programmed for at least one of a set temperature or time. The programming buttons 32 might include common cooking parameters, such as “time,” “pressure,” “temperature,” as well as “cancel” and “program” buttons. The programming buttons 32 should also include buttons for switching between each of the two cooking methods: air fryer button 32b and pressure cooker button 32a.

FIG. 6 illustrates the electrical connection between the interface 18 and the controller 26, and between the controller 26, a heating element 50, positioned in the bottom of the base 12, and an electrical connector 52, positioned proximate the open end of the base 12. These components are discussed in greater detail below.

As shown in FIGS. 7 and 8, the base 12 of appliance 10 is open at the upper end 40. A cooking chamber 42 is defined within the base 12 and a periphery of the open end 40 includes several locking flanges 44 for securing the pressure cooker lid 14.

Referring now to FIGS. 9-14, the pressure cooker lid 14 can be more readily understood. The lid 14 comprises a handle 54 to facilitate rotation between an unlocked position and a locked position. A pressure indicator 56 and a pressure release valve 58 are also positioned on the pressure cooker lid 14. The indicator 56 will extend upward when a sufficient pressure is reached in the cooking chamber 42. This provides a visual indication to a user that the chamber is pressurized and it is not safe to unlock the lid 14. As shown in FIG. 10, the valve 58 may be opened to release pressure and closed for the cooking process.

FIGS. 12 and 13 show the underside of pressure cooker lid 14. The lid 14 includes a silicone seal 60 to prevent pressure leaks and locking flanges 62 about a periphery of the rim 64. When properly positioned on the base 12 (see FIGS. 9 and 10), the flanges 62 of the lid 14 will engage corresponding locking flanges 44 on the base 12, as explained further below (see FIG. 22).

With reference to FIGS. 15-18, the air fryer lid 16 is shown. The top of the lid 16 comprises a handle 70 for lifting of the lid 16 from the base 12. Within the lid 16 is housed a heating element 72, preferably infrared, and a fan 74, preferably high-speed. These two components work together to produce heated, cyclonic air which is delivered to the cooking chamber 42. The lid 16 also includes a power connector 76 for coupling to a corresponding connector 52 located on the base 12 (see FIG. 19). The connector 76 brings electric power from the base unit 12, provided by a power cord 78, to the heating element 72 and fan 74. The connector 76 also couples the air fryer lid 16 to the electronic controller 26 in the base unit 12. The air fryer lid 16 does not lock onto the base, but the appliance 10 does include a safety switch 80 (FIG. 19) which prevents activation of the heat source in the base 12 when the air fryer lid 16 is properly positioned on the base 12.

The base 12 of the appliance is configured to accept each of the two different cooking lids, 14 and 16, and provide control for each through the programmable electronic controller 26. The base 12 is illustrated in FIGS. 19-24 of the appended drawings.

The base 12 includes an outer housing 30 having vents 84 and a power cord 78. Within the housing 30 is the cooking chamber 42 defined by a conductive metal vessel 90 with an open top end. The vessel 90 includes an upper peripheral edge having locking flanges 62 which correspond to the flanges 44 on the underside of the pressure cooker lid 14 (see FIG. 13). When rotated on the base 12, the lid flanges 44 engage the base flanges 62 and lock the lid 14 in a sealed and closed position for cooking.

The base 12 also includes a heating element 50 positioned in the bottom of the vessel 90 to heat the contents of the cooking chamber 42 (see FIG. 24). A water drawer 100 is positioned at the back of the base 12 (see FIG. 23) to catch liquids during any pressure cooking.

### Operational Instructions

The following is an outline of a few operational input, display and cooking algorithms for embodiments of the disclosed appliance 10. Reference is made to the preprogrammed buttons 30 and programming buttons 32 on the user interface 18.
I. General Functions: Functions that apply to Pressure Cooking, Air Frying, and Combo Cooking
   A. When the unit is plugged into a power source, the unit will power on and go into standby mode.
   B. The LED display will show “--:--”.
      1. If the [PRESSURE COOKER] button is pressed, the Blue LED lights on the [SEAR], [WARM], [TIME], [PROG], and [PRESSURE] buttons will light up indicating that function has been input into the unit. The LED display will light the words in the LED display and will stay solid indicating that function has been input into the unit.
      2. If the [AIR FRYER] button is pressed, the Blue LED lights on the [SEAR], [PREHEAT], [DELAY], [WARM], [TEMP], [TIME], [PROG], and [STAGE] buttons will light up indicating those functions are available for use. As functions are put into the unit, the LED display will light the words in the LED display and will stay solid indicating that function has been input into the unit.
      3. If the [COMBO COOKING] button is pressed, the PRESSURE COOKER function buttons will light first. Once PRESSURE COOKING functions are input into the unit, user presses [COMBO COOKING] button again to switch over to AIR FRYER functions and its corresponding buttons will light up on the buttons. As functions are put into the unit, the LED display will light the words in the LED display and will stay solid indicating that function has been input into the unit.
   C. During cooking the LED display will show:
      1. The remaining cooking time countdown.
      2.The “:” and the current cooking function will flash during cooking in the LED display. If paused (not available during pressure cooking), the “:” will become solid until the [START/PAUSE] button is pressed.
      3. When the remaining time is less than 1-minute, it will do a second's countdown. EXAMPLE: if 48 seconds are left in cooking, the LED display will be :48, :47, :46, etc.
      4. All functions set for cooking will remain lit and solid in the LED display. As a function finishes its cooking cycle, the function will no longer be displayed.
      5. During preheating, “pre” and the set preheat temperature will flash on the LED display.
      6. While using the probe, the LED display will show the current internal temperature reading of the probe.
   D. If there is a number shown on the LED display, the user can adjust the number up or down by turning the [START/PAUSE] button.
   E. When any button is pressed the unit will come with one beep sound.
   F. When cooking has finished, the unit will beep three (3) times and the LED display will show “End”.
   G. If the [CANCEL] button is pressed at any time, the unit will cancel all current actions and will go into standby mode.
   H. No matter how the functions are input, the cooking sequence will be the same as follows:
      1. Pressure Cooking:
      DELAY
      PREHEAT
      PRESSURE COOK
      WARM
      2.Air Fry Cooking:
      DELAY
      PREHEAT
      SEAR 1
      STAGE 1˜5
      SEAR 2
      WARM
      3.Combo Cooking:
      DELAY
      PREHEAT
      PRESSURE COOK
      SEAR 1
      STAGE 1˜5
      SEAR 2
      WARM
   Error Signs:
      1. ER1: Probe short circuit
      2. ER2: NTC temperature sensor short circuit.
      3. ER3: NTC temperature sensor open.
      4. ER4: NTC temperature sensor over-heated.
      5. ER5: Top heater is in abnormal condition.
      6. ER6: Bottom heater is in abnormal condition.
II. Pressure Cooker Functions:
   A. General Functions:
      1. Default cooking time: 00:15 (15-minutes)
      2. Minimum selectable Time: 00:01 (1-minute)
      3. Maximum selectable Time: 00:01˜01:40 (1-hr, 40-min.)
      4. Delay Time Default: 01:00 (1-hr)
      5. Selectable Delay Time: 00:05˜04:00 (5 min. to 4-hrs.)
      6. Sear Time Default: 00:05 (5-minutes)
      7. Sear selectable time: 00:00˜00:20 (0-min. to 20-min.)
      8. Warm Time Default: 01:00 (1-hour)
      9. Warm Selectable Time: 00:00˜04:00 (0-min. to 4-hrs.)
   B. Plug unit into power source. Display will show “--:--”.
      1. Press the [PRESSURE COOKER] button.
      2. The Blue LED lights on the [SEAR], [WARM], [TIME], [PROD], and [PRESSURE] buttons will light up indicating those functions are available for use. The LED Display will show “pressure cooker”, “high”, “00:00”, and “open” (if lid off or open).
      3. As functions are put into the unit, the LED display will light the words in the LED display and will stay solid indicating that function has been input into the unit.
      4. [PREHEAT], [TEMP], [DELAY], & [STAGE] BUTTONS WILL NOT WORK WHILE IN PRESSURE COOKER MODE
   C. START/PAUSE Function:
      1. Press [START/PAUSE] button to begin the cooking process.
         NOTE: pause is disabled during pressure cooking. Pressing the [START/PAUSE] button during pressure cooking will do nothing.
      2. Turn the [START/PAUSE] dial to adjust up or down in the LED display.
   D. Quick Start:
      1. Plug unit into power source. Display will show “--:----”.
      2. Press the [PRESSURE COOKER] button.
      3. The Blue LED lights on the [SEAR], [WARM], [TIME], [PROG], and [PRESSURE] buttons will light up indicating those functions are available for use. The LED Display will show “pressure cooker”, “high”, and “open” (if lid off or open) will all be lit solid in the LED display.
      4. Press [PROG] button, “pressure cooker”, “prog”, “1”, “high”, and “open” (if lid off or open) will all be lit solid in the LED display.
      5. Turn the [START/PAUSE] dial to the right (clockwise) to move the program numbers up (1,2,3, etc.) or to the left (counter clockwise) to move the program numbers down (100, 99, 98, etc.) the LED Display defaults will change as each program selection is scrolled through.
      6. Once the desired program number shows in the LED display screen, press the [START/PAUSE] button to begin cooking.
      7. The LED display will show “pressure cooker”, “prog”, “high”, and “PH”. NOTE: PH indicates the unit is preheating/pressurizing.
      8. Once the unit comes to pressure the unit will ˜beep˜ one (1) time and will begin to cook at the default time for the program chosen.
      9. The LED display will show “pressure cook”, “prog”, “high” or “low” (depending on program parameters), “time”, and cooking time countdown. During Cooking the “:” will flash.
      10. Once cooking is complete, the unit will ˜beep˜ three (3) times and the LED display will show “End”.
   E. Custom Cook:
      1. Plug unit into power source. Display will show
      2. Press the [PRESSURE COOKER] button.
      3. The Blue LED lights on the [SEAR], [WARM], [TIME], [PROD], and [PRESSURE] buttons will light up indicating those functions are available for use. The LED Display will show “Pressure cooker”, “high”, and “open” (if lid off or open) will all be lit solid in the LED display.
      4. To set custom settings, press the [TIME] button. The Display will show “00:15” (default). Use the [START/PAUSE] dial to adjust to the desired cooking time.
      5. To change pressure, press the [PRESSURE] button. The LED Display will turn on “low”. This indicates that low pressure is now activated. Press the [PRESSURE] button again to turn pressure off. To go back to high pressure, simply press the [PRESSURE] button again and the LED display will turn on “high” indicating high pressure is again activated.
      6. Press the [SEAR] and [WARM] buttons to add those functions if desired.
      7. Press [START/PAUSE] button to begin cooking.
      8. The LED display will show “pressure cooker”, “high” or “low” (depending on setting chosen), and “PH”. PH indicates the unit is preheating/pressurizing.
      9. Once the unit comes to pressure the unit will ˜beep˜ one (1) time and will begin to cook at the time chosen.
      10. The LED display will show “pressure cook”, “high” or “low” (depending on settings chosen), “time”, cooking time countdown, and any other cooking function added. During Cooking the “:” will flash.
      11. Once cooking is complete, the unit will ‘beep’ three (3) times and the LED display will show “End” and “ready”.
         NOTE: The user can add the warm function at this point as well. EXAMPLE: Pressure cook on high pressure for 45-minutes then keep warm for 30-minutes after cooking.
         Press [PRESSURE COOKER]→Press [TIME]→Turn [START/PAUSE] dial to adjust cooking time to “00:45”→Press [PRESSURE] until “high” is lit in the LED display→Press [WARM]→Turn the [START/PAUSE] dial to adjust warming time to “00:30”→Press [START/PAUSE]
   F. SEAR Function: Default 5-minutes; Maximum 20-minutes
      1. Plug unit into power source. Display will show “--:--”.
      2. Press the [PRESSURE COOKER] button.
      3. The Blue LED lights on the [SEAR], [WARM], [TIME], [PROG], and [PRESSURE] buttons will light up indicating those functions are available for use. The LED Display will show “pressure cooker”, “high”, and “open” (if lid off or open) will all be lit solid in the LED display.
      4. Press [SEAR]. The LED Display will show “pressure cooker”, “sear”, “time”, and “00:05”.
      5. Turn the [START/PAUSE] dial to adjust sear time up 20-minutes.
      6. Press [START/PAUSE] button to start searing.
         NOTE: the sear function SHOULD NOT work if the pressure cooker lid is on or locked into place.
   G. TIME Function: Default 15-minutes
      1. Plug unit into power source. Display will show “--:--”.
      2. Press the [PRESSURE COOKER] button.
      3. The Blue LED lights on the [SEAR], [WARM], [TIME], [PROG], and [PRESSURE] buttons will light up indicating those functions are available for use. The LED Display will show “pressure cooker”, “high”, and “open” (if lid off or open) will all be lit solid in the LED display.
      4. 4. Press the [TIME] button. The LED Display will show “00:15” (default). Use the [START/PAUSE] dial to adjust to the desired cooking time.
      5. To adjust time during cooking, press the [TIME] button and use the [START/PAUSE] dial to adjust to new time.
   H. PRESSURE Function: Default “high”
      1. Plug unit into power source. Display will show “--:--”.
      2. Press the [PRESSURE COOKER] button.
      3. The Blue LED lights on the [SEAR], [WARM], [TIME], [PROG], and [PRESSURE] buttons will light up indicating those functions are available for use. The LED Display will show “pressure cooker”, “high”, and “open” (if lid off or open) will all be lit solid in the LED display.
      4. Press the [PRESSURE] button. The LED display will show “low” lit and “high” will no longer be lit.
      5. Press the [PRESSURE] button again and neither “high” or “low” will be lit in the LED display. This indicates that pressure has been turned off and the unit will not pressurize.
      6. Press the [PRESSURE] button a third (3^{rd}) time and “high” will again light up in the LED display.
   I. WARM Function:
      1. Plug unit into power source. Display will show “--:--”.
      2. Press the [PRESSURE COOKER] button.
      3. The Blue LED lights on the [SEAR], [WARM], [TIME], [PROG], and [PRESSURE] buttons will light up indicating those functions are available for use. The LED Display will show “pressure cooker”, “high”, and “open” (if lid off or open) will all be lit solid in the LED display.
      4. Press the [WARM] button. The LED display will show “pressure cooker, “time”, “high”, “warm” and “01:00” (default).
      5. Turn the [START/PAUSE] dial to adjust warm time up to “04:00” (4-hrs).
      6. Press the [START/PAUSE] button to begin cooking. The unit will go through the cooking process then go into the warm mode after.
   J. PROG Function: Program Function:
      1. Plug unit into power source. Display will show “--:--”.
      2. Press the [PRESSURE COOKER] button.
      3. The Blue LED lights on the [SEAR], [WARM], [TIME], [PROG], and [PRESSURE] buttons will light up indicating those functions are available for use. The LED Display will show “pressure cooker”, “high”, and “open” (if lid off or open) will all be lit solid in the LED display.
      4. Press [PROG] button. “pressure cooker”, “prog”, “1”, “high”, and “open” (if lid off or open) will all be lit solid in the LED display.
      5. Turn the [START/PAUSE] dial to the right (clockwise) to move the program numbers up (1, 2, 3, etc.) or to the left (counter-clockwise) to move the program numbers down (100, 99, 98, etc.) The LED Display defaults will change as each program selection is scrolled through.
      6. Once the desired program number shows in the LED display screen, press the [START/PAUSE] button to begin cooking.
      7. Pressure Cooking Categories:

| | Kpa | Default | Minimum | Maximum |
|---|---|---|---|---|
| Category | Pressure | Time | Time | Time |
| 1. Meat/Stews | High | 00:40 | 00:01 | 02:00 |
| 2. Grains | High | 00:25 | 00:01 | 02:00 |
| 3. Rice | Low | 00:10 | 00:01 | 02:00 |
| 4. Steam | Low | 00:05 | 00:01 | 02:00 |
| 5. Beans/Chili | High | 00:20 | 00:01 | 02:00 |
| 6. Seafood | Low | 00:08 | 00:01 | 02:00 |
| 7. Slow Cook | Off | 04:00 | 02:00 | 08:00 |
| 8. Oatmeal | Low | 00:10 | 00:01 | 02:00 |
| 9. Cake | Low | 00:40 | 00:01 | 02:00 |

III. Air Fryer Functions:
   A. General Functions:
      1. Default cooking temperature: 360 F
      2. Default cooking time: 15-minutes
      3. Minimum selectable cooking temperature: 100 F
      4. Maximum selectable cooking temperature: 400 F
      5. Selectable cooking time
         i. 100 F˜160 F: 00:00˜24:00 (0-min. to 24-hrs.)
         ii. 165 F˜345 F: 00:00˜05:00 (0-min. to 5-hrs.)
         iii. 350 F˜400 F: 00:00˜01:00 (0-min. to 1-hr.)
      6. Delay Time Default: 01:00 (1-hr)
      7. Sear Temperature Default: 425 F
      8. Sear Minimum selectable temperature: 100 F
      9. Sear Maximum selectable temperature: 425 F
      10. Sear Time Default: 5-minutes
      11. Sear selectable time: 00:00˜00:05 (0 min. to 5-min.)
      12. Stage Default Temperature and Time: 360 F; 00:00 (no time for stages 2˜5)
      13. Warm Temperature Default: 140 F
      14. Warm Minimum selectable temperature: 100 F
      15. Warm Maximum selectable temperature: 145 F
      16. Warm Time Default: 1-hour
      17. Warm Selectable Time: 00:00˜03:00 (0-min. to 3-hrs.)
      18. Probe Default Temperature: 160 F
      19. Probe Temperature Range: 100 F˜210 F
   B. Plug unit into power source. Display will show “--:--”.
      1. Press the [AIR FRYER] button.
      2. The Blue LED lights on the [SEAR], [PREHEAT], [DELAY], [WARM], [TEMP], [TIME], [FROG], [PROBE], and [STAGE] buttons will light up indicating those functions are available for use. The LED Display will show “air fry”, “temp”, “OF” and “open” (if lid off or open).
      3. As functions are put into the unit, the LED display will light the words in the LED display and will stay solid indicating that function has been input into the unit.
   C. THE [PRESSURE] BUTTON WILL NOT WORK WHILE IN AIR FRYER MODE.
   D. START/PAUSE Function
      1. Press [START/PAUSE] button to begin the cooking process.
      2. Press [START/PAUSE] button to pause cooking. During pause the “:” will become solid indicating the unit is in pause mode.
      3. Press [START/PAUSE] button again to resume cooking. The “:” will begin to flash again indicating the unit is cooking.
      4. Turn the [START/PAUSE] dial to adjust settings up or down in the LED display.
   E. Quick Start:
      1. Plug unit into power source. Display will show “--:--”.
      2. Press the [AIR FRYER] button.
      3. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” (default) and “open” (if lid off or open).
      4. Close lid and press the [START/PAUSE] button to begin cooking.
      5. The LED display will show “air fry, “time”, remaining cook time countdown and any other function that pertains to that cooking program (Ex. “sear”, “stage” or “warm”).
      6. During Cooking the “:” will flash. Press [START/PAUSE] to pause cooking. The “:” will remain solid during pause mode.
      7. Press [START/PAUSE] again to continue cooking; the “:” will begin flashing again to indicate the unit is running.
      8. Once cooking is complete, the unit will ˜beer˜ three (3) times and the LED display will show “End” and “ready”.
   F. Custom Cook:
      1. Plug unit into power source. Display will show “--:--”.
      2. Press the [AIR FRYER] button.
      3. The Blue LED lights on the [SEAR], [PREHEAT], [DELAY], [WARM], [TEMP], [TIME], [PROG], PROBE], and [STAGE] buttons will light up indicating those functions are available for use. The LED Display will show “air fry”, “temp”, “360 F” and “open” (if lid off or open).
      4. To set custom settings, turn the [START/PAUSE] dial to adjust desired cooking temperature setting.
      5. Press the [TIME] button. The Display will show “00:15” (default). Use the [START/PAUSE] dial to adjust to the desired cooking time.
      6. Press the [SEAR], [PREHEAT], [DELAY], [DELAY], [WARM],[PROG], [PROBE], and [STAGE] buttons to add those function if desired.
      7. Press [START/PAUSE] button to begin cooking.
      8. The LED display will show “air fry”, “time”, cooking time countdown, and any other cooking function added. During Cooking the “:” will flash.
      9. Once cooking is complete, the unit will ˜beep˜ three (3) times and the LED display will show “End” and “ready”.
   G. TEMP Function: Default 360 F; Minimum 100 F, Maximum 400 F
      1. Press the [TEMP] button. The LED Display will show “360 F” (default). Use the [START/PAUSE] dial to adjust to the desired cooking temperature.
      2. To adjust temperature during cooking, press the [TEMP] button and use the [START/PAUSE] dial to adjust to new temperature.
   H. TIME Function: Default 15-minutes
      1. PRESS the [time] BUTTON. THE led Display will show “00:15” (default). Use the [START/PAUSE] dial to adjust to the desired cooking time.
      2. To adjust time during cooking, press the [TIME] button and use the [START/PAUSE] dial to adjust to new time.
      3. Selectable cooking time
         i. 100 F˜160 F: 00:00˜24:00 (0-min. to 24-hrs.) ii.
         165 F˜345 F: 00:00˜05:00 (0-min. to 5-hrs.) iii.
         350 F˜400 F: 00:00˜01:00 (0-min. to 1-hr.)
   I. DELAY Function: Default 1-hour; Maximum 4-hours
      1. Plug unit into power source. Display will show “--:--”.
      2. Press the [AIR FRYER] button
      3. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
      4. Press the [DELAY] button. The LED display will show “air fry, “time”, “delay” and “01:00” (default.
      5. Turn the [START/PAUSE] dial to adjust delay time up to “04:00” (4-hrs.).
      6. Press the [START/PAUSE] button to begin cooking. The unit will delay for adjusted time then go into the cooking process.
   J. PREHEAT Function: Default-Unit will preheat to set temperature of preceding cooking step (EX. Sear 1 set to 425, Unit will preheat to 425 F).
      1. Plug unit into power source. Display will show “--:--”.
      2. Press the [AIR FRYER] button.
      3. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
      4. Set cooking functions (i.e. Cooking temp & time, Sear 1 & 2, warm, etc.)
      5. Press the [PREHEAT] button. The LED display will show “air fry”, “pre”, “temp”, and set cooking temperature.
      6. Press the [START/PAUSE] button to begin preheating.
      7. During preheating, the LED display will show “360 F” or set temperature. “pre” “temp” will lit and stay solid, “360 F” will be flashing during preheat.
      8. Once the unit reaches the preheat temperature the unit will ˜beep˜ three (3) times and the LED display will show “5” and “ready”.
      9. The unit will begin a 5-minute countdown. If the [START/PAUSE] button is not pressed within that 5-minutes, the unit will go into standby mode.
      10. Place food into the unit, close the lid and press the [STAR/PAUSE] button to resume cooking.
   K. SEAR Function: Default: Temp—425 F, Time—5 minutes
      1. Sear 1: Sear 1 is ALWAYS the function right BEFORE the regular cooking stages.
         i. Press [SEAR] once. “sear”, “1”, “temp” & “425 F” will be display solid. “1” will flash.
         ii. Default sear temperature is 425 F and time is 5 minutes.
         iii. Press [START/PAUSE].
         iv. Unit will cook at 425 F for 5-minutes. And then cook at 360 F for 15 minutes. Once finished cooking, it will display “End” with three (3) ˜beep˜ sounds and “ready” will also display.
         v. If user wants to adjust the second phase (regular) cooking temperature & time (default 360 F, 1 minutes). For example: Cook at 375 F for 30 min.
         1. Press the [AIR FRYER] button.
         2. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
         3. Turn the [START/PAUSE] dial to adjust cooking temperature to 375 F.
         4. Press the [TIME] button. The LED display will switch to “00:15”.
         5. Turn the [START/PAUSE] dial to adjust cooking time to 00:30.
         6. Press [SEAR] once.
         7. Press [START/PAUSE]. It will cook:
         a. Sear at 425 F for 5-minutes.
         b. Cook at 375 F for 30 min.
         c. Finish cooking with three (3) ˜beep˜ and display “End” & “ready”.
      2. Sear 1 2: Sear 1 is ALWAYS the function right BEFORE the regular cooking stages and Sear 2 is AFTER the regular cooking stages.
         i. Press [SEAR] two (2) times. “sear”, “1”, “2”, “temp” & “425 F” will be display solid. “2” will flash.
         ii. Default sear temperature is 425 F and time is 5-minutes. iii. Press [START/PAUSE].
         iv. UNIT WILL SEAR AT 425 F FOR 5-MINUTES (SEAR 1) then cook at 360 F for 15 minutes Then sear again to 425 F for 5-minutes (sear 2). Once Finish cooking with three (3) ˜beep˜ and display “End” & “ready”.
         v. If user wants to adjust the second phase (regular) cooking temperature & time (default 360 F, 15 minutes). For example: Cook at 375 F for 30 min.
         1. Press the [AIR FRYER] button.
         2. The Blue LED lights on the [SEAR], [PREHEAT], [DELAY], [WARM], [TEMP], [TIME], [PROD], [PROBE], and [STAGE] buttons will light up indicating those functions are available for use. The LED Display will show “air fry”, “temp”, “360 F” and “open” (if lid off or open).
         3. Turn the [START/PAUSE] dial to adjust cooking temperature to 375 F.
         4. Press the [TIME] button. The LED display will switch to “00:15”.
         5. Turn the [START/PAUSE] dial to adjust cooking time to 00:30.
         6. Press [SEAR] two (2) times.
         7. Press [START/PAUSE]. It will cook:
         a. Sear at 425 F for 5-minutes (sear 1).
         b. Cook at 375 F for 30 min.
         c. Sear at 425 F for 5-minutes (sear 2)
         d. Finish cooking with three (3) ˜beeps˜ and display “End” & “ready”.
      3. Sear 2: Sear 2 is ALWAYS the function AFTER the regular cooking stages.
         i. Press [SEAR] three (3) times. “sear”, “2”, “temp” & “425 F” will be display solid. “2” will flash.
         ii. Default sear temperature is 425 F and time is 5 minutes. iii. Press [START/PAUSE].
         iv. Unit will cook at 360 F for 15 minutes. Then will sear at 425 F for 5-minutes (sear 2). Once finished cooking, it will display “End” with three (3) ˜beep˜ sounds and “ready” will also display.
         v. If user wants to adjust the regular cooking temperature & time (default 360 F, 15 minutes). For example: Cook at 375 F for 30 min.
         1. Press the [AIR FRYER] button.
         2. The Blue LED lights on the [SEAR], [PREHEAT], [DELAY], [WARM], [TEMP], [TIME], [PROD], [PROBE], and [STAGE] buttons will light up indicating those functions are available for use. The LED Display will show “air fry”, “temp”, “360 F” and “open” (if lid off or open).
         3. Turn the [START/PAUSE] dial to adjust cooking temperature to 375 F.
         4. Press the [TIME] button. The LED display will switch to “00:15”.
         5. Turn the [START/PAUSE] dial to adjust cooking time to 00:30.
         6. Press [SEAR] three (3) times.
         7. Press [START/PAUSE]. It will cook:
         a. Cook at 375 F for 30 min.
         b. Sear at 425 F for 5-minutes.
         c. Finish cooking with three (3) ˜beeps˜ and display “End” & “ready”.
      4. Press the [SEAR] button four (4) times to turn sear function off.
   L. STAGE Function:
      1. Plug unit into power source. Display will show “--:--”.
      2. Press the [AIR FRYER] button.
      3. The Blue LED lights on the [SEAR], [PREHEAT], [DELAY], [WARM], [TEMP], [TIME], [PROD], [PROBE], and [STAGE] buttons will light up indicating those functions are available for use. The LED Display will show “air fry”, “temp”, “360 F” and “open” (if lid off or open).
      4. Press [STAGE] one (1) time. The LED display will show “air fry”, “temp”, “stage”, “2” and “360 F”.
      5. The cook temp for Stage 1˜5 will be set at the default of 360 F.
      6. The Cook Time for stage 1 will be set at the default of 15 min. you can change the desired cooking temp/time at this time.
      7. The Cook Time for stage 2˜5 will be set at the default of 0 min. you can change the desired cooking time.
         i. Press the [TIME] button. The LED Display will show “00:00” (default for Stages 2˜5). Use the [START/PAUSE] dial to adjust to the desired cooking time.
         ii. To adjust time during cooking, press the [TIME] button and use the [START/PAUSE] dial to adjust to new time.
         iii. Selectable cooking time
         1. 100 F˜160 F: 00:00˜24:00 (0-min. to 24-hrs.)
         2. 165 F˜345 F: 00:00˜05:00 (0-min. to 5-hrs.)
         3. 350 F˜400 F: 00:00˜01:00 (0-min. to 1-hr.)
      8. The default cooking temperature for Stages 2˜5 is 360 F.
         i. Press the [TEMP] button. The LED Display will show “360 F” (default). Use the [START/PAUSE] dial to adjust to the desired cooking temperature.
         ii. To adjust temperature during cooking, press the [TEMP] button and use the [START/PAUSE] dial to adjust to new temperature.
      9. Press [STAGE] again, then you can set desired cooking for the next stage.
      10. You can enter up-to 5 stages.
      11. After you set stage 5, press [STAGE] again, it will display stage 1 data.
      12. Press [START/PAUSE] when you are done entering all the stages.
   M. WARM Function:
      1. Plug unit into power source. Display will show “--:--”.
      2. Press the [AIR FRYER] button.
      3. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
      4. Press the [WARM] button. The LED display will show “air fry”, “temp”, “warm” and “140 F” (default).
      5. Turn the [START/PAUSE] dial to adjust warm temperature up to 200 F.
      6. Press the [TEMP/TIME] button.
      7. Turn the [START/PAUSE] dial to adjust warm time up to “03:00” (3-hrs.).
      8. Press the [START/PAUSE] button to begin cooking. The unit will go through the cooking process then go into the warm mode after.
   N. Warm used as a single function.
      1. Plug unit into power source. Display will show “--:--”.
      2. Press the [AIR FRYER] button.
      3. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
      4. Press and hold [WARM] for 2-seconds. It will come with 2 beep sound. The Unit will begin to warm.
   O. PROG Function: Program Function:
      1. Plug unit into power source. Display will show“--:--”.
      2. Press the [AIR FRYER] button.
      3. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
      4. Press [PROG] button. “air fry”, “grog”, “1”, and “temp” will all be lit solid in the LED display.
      5. Turn the [START/PAUSE] dial to the right (clockwise) to move the program numbers up (1, 2, 3, etc.) or to the left (counter clockwise) to move the program numbers down (100, 99, 98, etc.) The LED Display defaults will change as each program selection is scrolled through.
      6. Once the desired program number shows in the LED display screen, press the [START/PAUSE] button to begin cooking.
      7. To Program your own recipe:
         i. Plug unit into power source. Display will show “--:--”. ii. Press the [AIR FRYER] button.
         iii. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
         iv. User sets cooking functions as they desire.
         v. Press [PROG]. “prog” & “101” will show on display solid. This is the first number of consumer program. Turn the [START/PAUSE] dial to choose number to save to (from number 101 to 200).
         vi. Press [PROG] again to store it.
         vii. Press [START/PAUSE], the unit will begin cooking. User can Recall later.
      8. Program recipe after cooking:
         i. Plug unit into power source. Display will show “--:--”. ii. Press the [AIR FRYER] button.
         iii. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
         iv. User sets cooking functions as they desire.
         v. Press [START/PAUSE]. Unit will go through the cooking process. vi. Once cooking is finished and “End” is displayed, press [PROG]. “prog” & “101” will show on display solid. This is the first number of consumer program.
         vii. Turn the [START/PAUSE] dial to choose number to save to (from number 101 to 200).
         viii. Press [PROG] again to store it
         ix. Press [START/PAUSE], the unit will begin cooking. User can Recall later.
      9. Program recipe during cooking:
         i. Plug unit into power source. Display will show “--:--”. ii.
         Press the [AIR FRYER] button.
         iii. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
         iv. User sets cooking functions as they desire.
         v. Press [START/PAUSE]. Unit will go through the cooking process. vi. During cooking, Press [PROG]. “prog” & “101” will show on display solid. This is the first number of consumer program.
         vii. Turn the [START/PAUSE] dial to choose number to save to (from number 101 to 200).
         viii. Press [PROG] again to store it
         ix. Press [START/PAUSE], the unit will begin cooking. User can Recall later.
   P. Probe: Default probe temperature is 160 F. probe temperature range 100 F˜210 F.
      1. Plug unit into power source. Display will show “--:--”.
      2. Press the [AIR FRYER] button.
      3. The Blue LED lights on the [SEAR], [PREHEAT], [DELAY], [WARM], [TEMP], [TIME], [PROG], [PROBE], and [STAGE] buttons will light up indicating those functions are available for use. The LED Display will show “air fry”, “temp”, “360 F” and “open” (if lid off or open).
      4. User can connect probe (component) to the unit and insert into the food.
      5. Press [PROBE], it displays “probe” and “160 F” (as default temperature) on LED screen, Turn the [START/PAUSE] dial to desired probe temperature.
      6. Push [START/PAUSE]. It will start to cook to desired probe temperature.
      7. During cooking, it will display current probe temperature, while it displays probe temperature, “probe” is lit.
      8. During cooking, press [TEMP/TIME] button, it will display chosen temperature of the oven (default 360 F); press [TEMP/TIME] button again, it will display remaining cooking time. While it's not displaying probe temperature, “probe” is no longer lit.
      9. Press [PROBE] button and hold for 2 seconds, it will display the set temperature of probe, with 2 beep sound. Then user can adjust desired probe temperature by using the [START/PAUSE] dial.
      10. Once user adjusted the temperature, it will stay to display temperature instead of counting down time, until user switch to time by pressing the [TEMP/TIME] button.
      11. If desired cooking time is finished but desired probe temperature is not achieved yet, continue cooking until probe temperature is achieved.
         i. Example:
         ii. Probe: 200 F
         iii. REGULAR COOKING: 380 F, 5 min
         iv. Sear 2: 400 F, 2 min
         v. Warm: 140 F, 30 min
      12. If probe temperature was not achieved under regular cooking 380 F,5 min, go to Sear 2, and if probe temperature is still no achieved in Sear 2, then go back to regular cooking (380 F) to continue cook until probe temperature is achieved, and then go to warm.
         i. After the set cooking time is finished but probe temperature still not achieved, it will continue cooking at the last cooking stage (as written above). meanwhile, if user press [TEMP/TIME] to see remaining cooking time, it will show “00:00” (as preset cooking time has run out already).
         ii. If the set cooking temperature is lower than target probe temperature, once user press [START/PAUSE] button, it will display “Prb 2” with 3 short beep sounds and cannot start cooking.
         iii. After user started cooking without probe, during cooking, after he inserts probe and press [PROBE] button, he can see probe temperature too. If he wants to adjust target probe temperature, press [PROBE] for two (2) seconds to adjust.
         iv. If probe is unplugged and user pushed Probe key, it will show “Prb 1” on the display with beep˜beep˜beep sound.
      13. Under setting mode, it will show “Prob”; after that, user can still push other keys (like temp/time, sear, etc.) to input other functions, but probe will not be activated.
      14. Under cooking mode, it will show “Prob”; after that, the unit will keep cooking until preset time, but probe will not be activated.
      15. While cooking, if you press the [PROBE] button, the word “Prob” will be lit and the LED Display will show the CURRENT temperature of the Probe. (For example, if you selected 160 F for the Probe desired temperature and after ten minutes of cooking, you press the Probe button, it could say 90 F as it is getting higher to that temperature).
      16. At any time, unplug probe, the probe function is canceled. Plug probe again and press [PROBE] key to restart the probe function.
      17. To avoid unsafe status (probe is shunted outside of the cavity, but oven started working with probe activated), the unit will be shut off when:
         i. If target cooking temperature is more than 250 F and Probe sensing temperature does not increase more than 5 F during first 60 min cooking, heating should be shut off immediately.
         Or,
         ii. If target cooking temperature is less than 250 F and Probe sensing temperature does not increase more than 5 F during first 120 min cooking, heating should be shut off immediately. When it shut off, it displays “Prb 3” as error notice to user.
IV. Combo Cooking Functions:
   A. Basic Function:
      1. Plug unit into power source. Display will show
      2. Press the [COMBO COOKING] button.
      3. The settings for PRESSURE COOKING will display on the control panel.
      4. Set Pressure cooking functions as described above in Pressure Cooking Functions section.
      5. Once all PRESSURE COOKING functions are set, press [COMBO COOKING] a second (2^{nd}) time.
      6. The setting for AIR FRY will now display on the control panel.
      7. Set the Air Fry cooking functions as described above in Air Fryer Functions section.
      8. Press the [START/PAUSE] button.
      9. The unit will first (1^{st}) cook pressure cooker functions.
      10. When Pressure Cooking functions are finished, User will release pressure and change from pressure cooking lid to air fryer lid and press [START/PAUSE] button.
      11. The unit will move into the air fry portion of cooking and will follow set Air Frying functions.
      12. Once finished cooking the Unit will ˜beer˜ three (3) times and display “End” and “ready”.

As shown in FIGS. 25-30, the appliance 10 can also include several optional components to assist in pressure cooking and air frying of food. FIGS. 25-26 illustrate an embodiment of the pressure cooker which may include a graduated stainless-steel bowl 20. The bowl 20 fits into the vessel 90 of the cooking chamber 42 to be heated by heating element 50 located beneath the vessel 90. The inside surface of the bowl 20 includes graduated markings to assist the user and prevent the use of excess liquid during the cooking process.

FIG. 27 illustrates a lid holder 104 which is designed to retain either of the cooking lids, 14 and 16, in a substantially vertical orientation. This feature helps prevent placement of a hot lid on other surfaces. Likewise, the air fryer embodiment may use a fryer basket 24 complete with a detachable stand 108, as shown in FIGS. 28-30.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An appliance for cooking food by two different methods, the appliance comprising:
a base having an outer surface, an inner cooking chamber open at an upper end, a first heating source coupled to the cooking chamber, an electronic controller for controlling the heating source, a power cord for connecting to a power source, and a user interface positioned on an outer surface and having a plurality of buttons for inputting cooking parameters to the electronic controller;
a first interchangeable lid securable to the base to cover the open end of the cooking chamber, the first interchangeable lid being movable on the base from a closed and locked position to a closed and unlocked position; and
a second interchangeable lid positionable atop the base to cover the open end of the cooking chamber, the second interchangeable lid comprising a second heating source, an air circulating device and a power connector configured to receive power through a corresponding power connector positioned on the base and electrically coupled to the power cord;
wherein the first interchangeable lid attaches to the base to create a cooking appliance configured for a first cooking method and the second interchangeable lid alternately attaches to the base to create a cooking appliance configured for a second cooking method different from the first cooking method.

2. The appliance of claim 1, further comprising:
at least one first locking flange positioned about a periphery of the open end of the cooking chamber; and
at least one second locking flange positioned about a periphery of an internal surface of the first interchangeable lid;
wherein the at least one second locking flange is operatively engageable with the at least one first locking flange to secure the first interchangeable lid to the cooking vessel in the closed orientation.

3. The appliance of claim 1, wherein the first interchangeable lid rotates about the open end of the cooking chamber to move from the locked position to the unlocked position.

4. The appliance of claim 1, wherein the first lid further comprises a visual pressure indicator which activates when an increased pressure is achieved in the cooking vessel

5. The appliance of claim 1, wherein the first heating source operates during the first cooking method and the second heating source operates during the second cooking method.

6. The appliance of claim 5, wherein the electronic controller controls the first heating source and the second heating source.

7. The appliance of claim 1, wherein the first interchangeable lid creates a pressure cooker when attached to the base.

8. The appliance of claim 1, wherein the second interchangeable lid creates an air fryer when positioned on the base.

9. The appliance of claim 7, wherein the second interchangeable lid creates an air fryer when positioned on the base.

10. The appliance of claim 9, wherein the pressure cooker and the air fryer can be automatically operated consecutively by the electronic controller.

11. The appliance of claim 1, wherein the electronic controller has a pre-programmed setting for automatically operating the appliance in the first cooking method when the first interchangeable lid is attached, and then in the second cooking method when the second interchangeable lid is positioned on the base.

12. The appliance of claim 1, wherein the electronic controller turns off the first heating source when the power connector on the second interchangeable lid connects to the corresponding power connector positioned on the base.

13. The appliance of claim 1, wherein the base further comprises a safety switch electrically coupled to the electronic controller to prevent operation of the first heating source when the first interchangeable lid is not in the closed and locked position.

14. The appliance of claim 3, further comprising a locking mechanism which prevents movement of the first interchangeable lid when in the closed and locked position.

15. The appliance of claim 4, wherein the visual pressure indicator comprises tamper-proofing to prevent bypassing the locking mechanism

16. The appliance of claim 1, wherein the second heating source comprises an infrared heating element.

17. The appliance of claim 1, wherein the user interface comprises programmable time and temperature buttons

18. The appliance of claim 1, wherein the plurality of buttons on the user interface comprises a plurality of preset cooking buttons.

19. The appliance of claim 18, wherein the preset cooking buttons comprises a button for combining the first and second cooking methods.

20. An air fryer system comprising:
a base having an outer surface, an inner cooking chamber open at an upper end, an electronic controller, a power cord for connecting to a power source, and a user interface positioned on an outer surface and having a plurality of buttons for inputting cooking parameters to the electronic controller;
a removable cooking basket configured to be positioned within the cooking chamber through the open upper end and to support food to be cooked in the cooking chamber; and
a lid positionable atop the base to cover the open end of the cooking chamber, the lid comprising a heating source controlled by the electronic controller, an air circulating device and a power connector configured to receive power through a corresponding power connector positioned on the base and electrically coupled to the power cord.

21. The air fryer system of claim 20, wherein the heating source comprises an infrared source.

22. The air fryer system of claim 20, wherein the user interface comprises programmable time and temperature buttons.

23. The air fryer system of claim 20, further comprising:
an alternate lid securable to the base to cover the open end of the cooking chamber, the alternate lid being movable on the base from a closed and locked position to a closed and unlocked position; and
an alternate heating source within the base coupled to the cooking chamber and controlled by the electronic controller.

24. The air fryer system of claim 23, wherein the air fryer is converted to a pressure cooker by the attachment of the alternate lid.

25. A method for preparing food in a single appliance by two consecutive different cooking methods, comprising:
providing an appliance comprising:
a base having an outer surface, an inner cooking chamber open at an upper end, a first heating source coupled to the cooking chamber, an electronic controller for controlling the heating source, a power cord for connecting to a power source, and a user interface positioned on an outer surface and having a plurality of buttons for inputting cooking parameters to the electronic controller;
a first interchangeable lid securable to the base to cover the open end of the cooking chamber, the first interchangeable lid being movable on the base from a closed and locked position to a closed and unlocked position; and
a second interchangeable lid positionable atop the base to cover the open end of the cooking chamber, the second interchangeable lid comprising a second heating source, an air circulating device and a power connector configured to receive power through a corresponding power connector positioned on the base and electrically coupled to the power cord;
placing food into the cooking chamber;
attaching the first interchangeable lid to the base and moving the lid to the closed and locked position;
inputting cooking parameters for a first cooking method using the user interface;
inputting cooking parameters for a second cooking method, different from the first cooking method, using the user interface;
activating the appliance to begin the first cooking method;
signaling the completion of the first cooking method;
detaching the first interchangeable lid from the base;
placing the second interchangeable lid onto the base;
activating the appliance to begin the second cooking method;
signaling the completing of the second cooking method;
removing the second interchangeable lid from the base; and
removing the food from the cooking chamber.

26. The method of claim 25, wherein the first cooking method is pressure cooking.

27. The method of claim 25, wherein the second cooking method is air frying.

28. The method of claim 26, wherein the second cooking method is air frying.

29. The method of claim 25, wherein the electronic controller activates the first heating element during the first cooking method and activates the second heating element during the second cooking method.
